(19) United States
(12) Patent Application Publication
(10) Pub. No.: US 2005/0220993 A1
(43) Pub. Date: Oct. 6, 2005

(54) Thin film of oxidic materials having a high dielectric constant

(75) Inventor: Hans-Josef Sterzel, Dannstadt-Schauernheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/527,548

(22) PCT Filed: Sep. 8, 2003
(86) PCT No.: PCT/EP03/09945

§ 371 Date: Apr. 29, 2005

(30) Foreign Application Priority Data
Sep. 23, 2002 (DE) 102 44 285.1
Dec. 19, 2002 (DE) 102 60 091.0

(51) Int. Cl. B05D 1/12; B05D 3/02

(52) U.S. Cl. 427/180; 427/372.2

(57) ABSTRACT

A substrate is coated by a process in which a finely divided suspension of crystalline oxide particles is applied to a substrate by coating, the suspending medium is evaporated and the coating on the substrate is sintered.

The present invention relates to a process for coating a substrate by applying a finely divided, stable suspension of crystalline oxide particles to the substrate, which, if required, is to be heated, by coating, evaporating the suspending medium and sintering at elevated temperatures.

Oxidic materials having a high dielectric constant, such as barium titanate, strontium titanate, mixed titanates of barium and strontium, lead zirconium titanates or strontium bismuth tantalate, are used as dielectrics or ferroelectrics for memory chips in microelectronics.

These materials on a substrate act as a dielectric if they are applied as a film in layer thicknesses of about 100 nm in crystalline form. A thermal treatment at from 300 to 1000° C. has to be carried out for producing a film.

It is known from Appl. Phys. A 69 (1999), 55-61 that such films can be obtained for the ferroelectric material SrBi₂Ta₂O₉ after mixing and calcining SrCO₃ with Bi₂O₃ and Ta₂O₅ and subsequent sintering of compressed pellets by means of laser irradiation (sputtering) on a substrate. The disadvantage of this process is that the stoichiometry of the material may change during the sputtering procedure and that the dielectric constant or the permanent polarizability may thus be adversely affected.

It was an object of the present invention to remedy the abovementioned disadvantages.

We have found that this object is achieved by a novel and improved process for coating a substrate, wherein a finely divided suspension of crystalline oxide particles is applied to a substrate by coating, the suspending medium is evaporated and the coating on the substrate is sintered.

The novel process can be carried out as follows:

The oxide suspensions can be sprayed by a suitable apparatus, such as a spray nozzle, onto a substrate which, if required, is heated to such a high temperature that the suspending medium evaporates. The evaporation can also be effected in a separate step by subsequent heating. A homogeneous spray cone can be achieved by coupling the spray nozzle(s) to an ultrasonic oscillator or superposing an ultrasonic oscillation during the metering or metering the suspension onto a suitably shaped ultrasonic oscillator. The spraying of the unheated or moderately heated (temperature from room temperature to below the boiling point of the suspending medium) suspension can be achieved in a binary nozzle by means of an auxiliary gas (for example nitrogen or argon) and/or by supporting the spray process, for example, by superposed ultrasonic oscillations.

The coating can be effected by spraying on or by a spin-on process in which a certain amount of flowable suspension is metered at any desired point, for example in the center, of a rotating substrate and the suspension is distributed uniformly over the substrate as a result of the centrifugal force.

After deposition of the oxide suspension on the substrate is complete, the system can be heated to the crystallization temperature adequate for the oxide and the desired cohesive film can be produced by sintering together the nanoparticles.

The sintering temperatures for the nanoparticles are as a rule substantially below the sintering temperature for the particles on the micrometer scale. For example, for BaTiO₃ particles, the sintering temperature is about 750° C. in the case of nanoparticles (particle sizes from 2 to 5 nm), in contrast to micrometer particles (particle sizes from 2 to 5 μm), for which it is about 1350° C.

There is no change in the stoichiometry of the applied oxides, as occurs in the case of other processes. Thus, films having superior dielectric or ferroelectric properties are obtained.

In the case of the suspensions of finely divided, crystalline oxide particles, as a rule water or organic suspending media are used, which contain the oxide particles with a mean particle size of from 0.5 to 9.9 nm, preferably from 0.6 to 9 nm, particularly preferably from 1 to 8 nm. The oxide particles are, for example, BaTiO₃, SrTiO₃, BaₓSr₁₋ₓTiO₃ where x=0.01 to 0.99, Pb(ZrₓTi₁₋ₓ)O₃ where x=0.01 to 0.99 or SrBi₂Ta₂O₉.

Suitable substrates are as a rule ultrapure silicon wafers which are already structured, the structuring being effected by the known damascene process. The actual substrate layers are electrically conductive layers which are produced in the course of the damascene process.

Suitable organic suspending media are as a rule polar organic suspending media, in particular aliphatic alcohols, ether alcohols or mixtures thereof, having a boiling point below about 300° C. under atmospheric pressure. These can be used in anhydrous form or, preferably, in commercial aqueous form.

Suitable alcohols are C₁- to C₈-alkanols, preferably C₁- to C₄-alkanols, such as methanol, ethanol, n-propanol, isopropanol, n-butanol, isobutanol, sec-butanol or tert-butanol, particularly preferably C₁- to C₃-alkanols, such as methanol, ethanol, n-propanol or isopropanol, in particular methanol or ethanol.

Suitable ether alcohols are all known glycol ethers, for example ethylene glycol monomethyl ether, ethylene glycol monoethyl ether, ethylene glycol mono-n-propyl ether, ethylene glycol monoisopropyl ether, ethylene glycol mono-n-butyl ether, ethylene glycol monoisobutyl ether, ethylene glycol mono-sec-butyl ether, ethylene glycol tert-butyl ether, diethylene glycol monomethyl ether, diethylene glycol monoethyl ether, diethylene glycol mono-n-propyl ether, diethylene glycol monoisopropyl ether, diethylene glycol mono-n-butyl ether, diethylene glycol monoisobutyl ether, diethylene glycol mono-sec-butyl ether, or diethylene glycol tert-butyl ether, preferably ethylene glycol monoethyl ether, ethylene glycol mono-n-propyl ether, ethylene glycol monoisopropyl ether, ethylene glycol mono-n-butyl ether, ethylene glycol monoisobutyl ether, ethylene glycol mono-sec-butyl ether, ethylene glycol tert-butyl ether, diethylene glycol monoethyl ether, diethylene glycol mono-n-propyl ether, diethylene glycol monoisopropyl ether, diethylene glycol mono-n-butyl ether, diethylene glycol monoisobutyl ether, diethylene glycol mono-sec-butyl ether and diethylene glycol tert-butyl ether, particularly preferably ethylene glycol mono-n-propyl ether, ethylene glycol monoisopropyl ether, ethylene glycol mono-n-butyl ether, ethylene glycol monoisobutyl ether, ethylene glycol mono-sec-butyl ether, ethylene glycol tert-butyl ether, diethylene glycol mono-n-propyl ether, diethylene glycol monoisopropyl ether, diethylene glycol mono-n-butyl ether, diethylene glycol monoisobutyl ether, diethylene glycol mono-sec-butyl ether and diethylene glycol tert-butyl ether, in particular ethylene glycol monoisopropyl ether, ethylene glycol monoisobutyl ether, ethylene glycol tert-butyl ether, diethylene glycol monoisopropyl ether, diethylene glycol monoisobutyl ether and diethylene glycol tert-butyl ether.

The solids content of the suspensions can be varied within wide limits, is as a rule from 1 to 35, preferably from 5 to 25, % by weight and can be established in the synthesis of the suspensions or subsequently by dilution or concentration.

The nanocrystalline oxide suspensions can be prepared as follows:

Titanium alcoholates in an alkanol, a glycol ether or a mixture thereof can be initially taken and reacted at from 50 to 150° C., preferably from 60 to 120° C., particularly preferably from 70 to 110° C., in particular at reflux temperature, and from 0.1 to 3, preferably from 0.5 to 2, bar, particularly preferably at atmospheric pressure, with barium hydroxide hydrate or strontium hydroxide hydrate.

The concentration of the alcoholic titanium alcoholate solution can be varied within wide limits. The concentration is preferably from 50 to 800, particularly preferably from 100 to 600, very particularly preferably from 200 to 400, g/liter.

Suitable barium hydroxide hydrates or strontium hydroxide hydrates are the known hydroxide hydrates, e.g. barium hydroxide octahydrate or strontium hydroxide octahydrate.

Suitable titanium alcoholates are, for example, titanium tetramethanolate, titanium tetraethanolate, titanium tetra-n-propanolate, titanium tetraisopropanolate, titanium tetra-n-butanolate, titanium tetraisobutanolate, titanium tetra-sec-butanolate, titanium tetra-tert-butanolate, titanium tetra-n-pentanolate and titanium tetraisopentanolate, preferably titanium tetraethanolate, titanium tetra-n-propanolate, titanium butanolate, titanium tetra-sec-butanolate and titanium tetra-tert-butanolate, particularly preferably titanium tetra-n-propanolate, titanium tetraisopropanolate, titanium tetra-n-butanolate and titanium tetraisobutanolate, or mixtures thereof.

For the preparation of Ba(ZrₓTi₁₋ₓ)O₃ or Sr(ZrₓTi₁₋ₓ)O₃ oxides, the mixtures with zirconium alkoxides are used instead of the pure titanium alkoxide and the conditions described above are used.

Zirconium alkoxides used are the commercially available alkoxides, preferably zirconium tetraisobutanolate and/or zirconium tetra-n-butanolate.

For the preparation of the Pb(ZrₓTi₁₋ₓ)O₃ oxides, the lead component used is as a rule lead acetate trihydrate or a mixture thereof with the basic lead acetate [Pb(OAc)₂.Pb(OH)₂]. By means of the mixing ratio of lead acetate trihydrate and basic lead acetate, the amount of the water of reaction can be predetermined, the acetate radicals being eliminated as acetic acid and the latter producing further water by ester formation with the alcohol present as component in the suspending medium. The addition of small amounts of additional acetic acid with formation of water of reaction may be advantageous.

For the preparation of SrBi₂Ta₂O₉, the alkoxide used is as a rule commercially available tantalum pentaethoxide Ta(OC₂H₅)₅ and the Sr component used is preferably Sr(OH)₂.8H₂O, if required as a mixture with anhydrous Sr(OH)₂, and the bismuth component used is Bi(OCOCH₃)₃ or bismuth hydroxide Bi(OH)₃.

It may be advantageous to support the introduction of the solids by vigorous stirring.

An advantageous embodiment comprises introducing no additional water into the oxide suspensions in the reaction, apart from the water from the components and from the suspending medium.

If required, doping elements, such as Mg, Ca, Zn, Zr, V, Nb, Ta, Bi, Cr, Mo, W, Mn, Fe, Co, Ni, Pb, Ce or mixtures thereof, preferably Mg, Ca, Cr, Fe, Co, Ni, Pb or mixtures thereof, for example in the form of their hydroxides, oxides, carbonates, carboxylates or nitrates, may be introduced.

The mixed oxides prepared according to the invention have, as a rule, a mean particle diameter of less than 10 nm, preferably from 5 to 9.9 nm, particularly preferably from 0.6 to 9 nm, in particular from 1 to 8 nm.

By means of the novel process, it is possible to obtain dielectric layers for DRAMs (Dynamic Random Access Memories), for example titanates, BaTiO₃, SrTiO₃ and Ba₁₋ₓSrₓTiO₃ (where x=0.01 to 0.99), or ferroelectric layers for FeRAMs, for example Pb (Zr₁₋ₓTiₓ)O₃ where x=0.01 to 0.99 or SrBi₂Ta₂O₉, which lead to superior dielectric or ferroelectric properties without changing the stoichiometry.

### EXAMPLES

### Example 1

Preparation of a Nanoparticle Barium Titanate Suspension

335.6 g of titanium tetrabutanolate and 79.6 g of Ba(OH)₂×8H₂O with 128.4 g of Ba(OH)₂ were added rapidly in succession to 844 g of butyl glycol and stirred for 48 hours at 120° C. A barium titanate suspension containing highly crystalline particles having a mean particle size of from 4 to 6 nm was obtained.

### Example 2

Preparation of a Nanoparticle SrBi₂Ta₂O₉ Suspension of <10 nm

40.6 g of tantalum ethanolate, 4.6 g of Sr(OH)₂ (Sr content: 70.4% by weight), 3.35 g of Sr(OH)₂×H₂O and 26 g of Bi(OH)₃ were added in succession to 110 g of butyl glycol and stirred for 48 hours under reflux (104° C.). A crystalline SrBi₂Ta₂O₉ suspension having a mean particle size of 5 nm was obtained.

### Example 3

Preparation of a Nanoparticle SrBi₂Ta₂O₉ Suspension of <10 nm

40.6 g of tantalum ethanolate, 1.55 g of Sr(OH)₂ (Sr content: 70.4% by weight), 10 g of Sr(OH)₂×H₂O and 26 g of Bi(OH)₃ were added in succession to 110 g of butyl glycol and stirred for 48 hours under reflux (104° C.). A crystalline SrBi₂Ta₂O₉ suspension having a mean particle size of 8 nm was obtained.

### Example 4

Preparation of a Nanoparticle Pb(Zr_{0.53}Ti_{0.47})O₃ Suspension

49.6 g of Zr(OC₃H₇)₄, 31.5 g of Ti(OC₄H₉)₄ and 75.8 g of Pb(OCOCH₃)₂×3H₂O were added in succession to 211 g of butyl glycol and stirred for 24 hours at 80° C. and for 24 hours at 120° C. A crystalline Pb(Zr_{0.53}Ti_{0.47})O₃ suspension having a mean particle size of from 2 to 3 nm was obtained.

### Example 5

Preparation of a Nanoparticle Pb(Zr_{0.53}Ti_{0.47})O₃ Suspension

49.6 g of Zr(OC₃H₇)₄, 31.5 g of Ti(OC₄H₉)₄, 24 g of acetic acid (100% strength) and 75.8 g of Pb(OCOCH₃)₂×3H₂O were added in succession to 211 g of butyl glycol and stirred for 24 hours at 80° C. and for 24 hours at 120° C. A crystalline Pb(Zr_{0.53}Ti_{0.47})O₃ suspension having a mean particle size of from 3 to 4 nm was obtained.

### Example 6

Preparation of a Nanoparticle Pb(Zr_{0.53}Ti_{0.47})O₃ Suspension

48.5 g of Zr(OC₄H₉)₄, 31.5 g of Ti(OC₄H₉)₄ and 75.8 g of Pb(OCOCH₃)₂×3H₂O were added in succession to 211 g of butyl glycol and stirred for 72 hours at 120° C. A crystalline Pb(Zr_{0.53}Ti_{0.47})O₃ suspension having a mean particle size of from 2 to 3 nm was obtained.

1. A process for coating a substrate, wherein a suspension of crystalline oxide particles in a suspending medium having a mean particle size from 0.5 to 9.9 nm is applied to a substrate to form a coating, the suspending medium is evaporated and the coating on the substrate is sintered.

2. A process for coating a substrate as claimed in claim 1, wherein oxide particles having a mean particle size of from 0.5 to 9.9 nm are used.

3. A process for coating a substrate as claimed in claim 1, wherein the oxide particles are BaTiO₃, SrTiO₃, BaₓSr₁₋ₓTiO₃ where x=0.01 to 0.99, Pb(ZrₓTi₁₋ₓ)O₃ where x=0.01 to 0.99, Bi₄₋ₓLaₓTi₃O₁₂ where x=0 to 4 or SrBi₂Ta₂O₉.

4. A process for coating a substrate as claimed in claim 1, wherein the suspending medium is an alcohol or a glycol ether.
